(19) United States
(12) Patent Application Publication
(10) Pub. No.: US 2025/0073997 A1
(43) Pub. Date: Mar. 6, 2025

(54) CARTRIDGE, SYSTEM, AND METHOD FOR VOLUMETRIC 3D PRINTING

(71) Applicant: QUADRATIC 3D, INC., CHARLESTOWN, MA (US)

(72) Inventors: SAMUEL N. SANDERS, ARLINGTON, MA (US); EMILY M. ARNDT, AKRON, OH (US)

(21) Appl. No.: 18/951,310

(22) Filed: Nov. 18, 2024

Related U.S. Application Data
(63) Continuation of application No. PCT/US2023/022896, filed on May 19, 2023.
(60) Provisional application No. 63/343,562, filed on May 19, 2022.
(60) Provisional application No. 63/400,448, filed on Aug. 24, 2022.

(51) Int. Cl. B29C 64/307; B29C 64/182; B29C 64/268; B33Y 10/00; B33Y 70/00

(52) U.S. Cl. CPC B29C 64/307; B29C 64/182; B29C 64/268; B33Y 10/00; B33Y 70/00

(57) ABSTRACT

The present invention includes a cartridge for printing one or more three-dimensional objects, the cartridge being configured to contain a volume of a photopolymerizable composition, the cartridge including side walls attached to a bottom wall to define a volume space for containing the volume, the cartridge being configured for including one or more printing zones, wherein a printing zone is sized to facilitate being irradiated by one or more, preferably at least two, excitation light projections to at least partially form a three-dimensional printed object within the volume of photopolymerizable composition in the printing zone. Systems and methods including a cartridge described herein are also disclosed.

### CROSS-REFERENCE TO RELATED APPLICATIONS

This application is a continuation of International Application No. PCT/US2023/022896, filed 19 May 2023, which International Application claims priority to U.S. Provisional Patent Application No. 63/343,562 of Quadratic 3D, Inc. filed May 19, 2022 for “Cartridge, System, and Method for Volumetric 3D Printing” and U.S. Provisional Patent Application No. 63/400,448 of Quadratic 3D, Inc. filed Aug. 24, 2022 for “Volumetric Three-Dimensional (3D) Printing System”, each of the foregoing being hereby incorporated herein by reference in its entirety for all purposes.

### TECHNICAL FIELD OF THE INVENTION

The present invention relates to the technical field of three-dimensional printing.

### BRIEF SUMMARY OF THE INVENTION

In accordance with one aspect of the present invention, there is provided a cartridge for printing one or more three-dimensional objects, the cartridge being configured to contain a volume of a photopolymerizable composition, the cartridge including side walls, preferably four, attached to a bottom wall to define a volume space for containing the volume, the cartridge being configured for including one or more printing zones, wherein a printing zone is sized to facilitate being irradiated by one or more, preferably at least two, excitation light projections to at least partially form a three-dimensional printed object within the volume of photopolymerizable composition in the printing zone. The cartridge can be open or can optionally include a cover, which can be removable, or a top wall opposite the bottom. Optionally at least one of the walls can include at least one openable/closable port for facilitating the introduction and/or removal of unpolymerized photopolymerizable composition and/or removal of one or more three-dimensional objects from the cartridge.

In accordance with another aspect of the present invention, there is provided a cartridge for printing one or more three-dimensional objects, the cartridge being configured to contain a volume of a photopolymerizable composition, the cartridge including opposed end walls and including at least one port in at least one end wall of the cartridge for facilitating the introduction and/or removal of unpolymerized photopolymerizable composition and/or removal of one or more three-dimensional objects from the cartridge, the cartridge being configured for including one or more printing zones, wherein a printing zone is sized to facilitate being irradiated by one or more, preferably at least two, excitation light projections to at least partially form a three-dimensional printed object within the volume of photopolymerizable composition in the printing zone.

In accordance with another aspect of the present invention, there is provided a system for printing one or more three-dimensional objects, the system comprising a cartridge configured to contain a volume of a photopolymerizable composition, the cartridge including side walls, preferably four, attached to a bottom wall to define a volume space for containing the volume, the cartridge being configured for including one or more printing zones, wherein a printing zone is sized to facilitate being irradiated by one or more, preferably at least two, excitation light projections to at least partially form a three-dimensional printed object within the volume of photopolymerizable composition in the printing zone; and one or more optical systems wherein an optical system is positioned or positionable to selectively direct one or more, preferably at least two, excitation light projections into a single printing zone.

In accordance with another aspect of the present invention, there is provided a system for printing one or more three-dimensional objects, the system comprising a cartridge configured to contain a volume of a photopolymerizable composition, the cartridge including opposed end walls and including at least one port in at least one end wall of the cartridge for facilitating the introduction and/or removal of unpolymerized photopolymerizable composition and/or removal of one or more three-dimensional objects from the cartridge, the cartridge being configured for including one or more printing zones, wherein a printing zone is sized to facilitate being irradiated by one or more, preferably at least two, excitation light projections to at least partially form a three-dimensional printed object within the volume of photopolymerizable composition in the printing zone; and one or more optical systems wherein an optical system is positioned or positionable to selectively direct one or more, preferably at least two, excitation light projections into a single printing zone.

A cartridge included in systems in accordance with the invention can optionally further include one or more of any of the cartridge features described herein.

A system in accordance with the present invention can optionally further include one or more additional components described herein.

A system in accordance with the present invention can optionally further include a separator unit for separating partially formed three-dimensional objects from unpolymerized photohardenable composition in the cartridge after printing.

A system can further include a recycling unit in connection with the separator unit for receiving the separated unpolymerized photopolymerizable composition.

Systems in accordance with the present invention can optionally further include one or more inspection units or zones (which may also be referred to herein as regions) that is preferably not light tight. An inspection unit can facilitate visualization and/or characterization (e.g., measurement, flaw-detection, etc.) of printed objects. An inspection unit or zone can be situated to permit inspection of printed parts after formation, e.g., prior to separation (if included), after separation (if included), and/or after post-treatment (if included). Optionally light may be projected into inspection zone for purposes of, e.g., visualization or measurement. Optionally ultrasound may be projected into an inspection zone for purposes of, e.g., visualization or measurement.

A system in accordance with the present invention can further include a post-treatment unit or region.

In accordance with another aspect of the present invention, there is provided a method of printing one or more three-dimensional objects, the method comprising:

providing a volume of a photopolymerizable composition in a cartridge for printing one or more three-dimensional objects, the cartridge being configured to contain a volume of a photopolymerizable composition, the cartridge including side walls, preferably four, attached to a bottom wall to define a volume space for containing the volume, the cartridge being configured for including one or more printing zones, wherein a printing zone is sized to facilitate being irradiated by one or more, preferably at least two, excitation light projections to at least partially form a three-dimensional printed object within the volume of photopolymerizable composition in the printing zone, and

directing the one or more, preferably at least two, excitation light projections into each printing zone to selectively induce a photopolymerization or cross-linking reaction in the photopolymerizable composition at one or more selected locations in the printing zone to at least partially form a three-dimensional object in the printing zone.

In accordance with another aspect of the present invention, there is provided a method of printing one or more three-dimensional objects, the method comprising:

providing a volume of a photopolymerizable composition in a cartridge configured to contain a volume of a photopolymerizable composition, the cartridge including opposed end walls and including at least one port in at least one end wall of the cartridge for facilitating the introduction and/or removal of unpolymerized photopolymerizable composition and/or removal of one or more three-dimensional objects from the cartridge, the cartridge being configured for including one or more printing zones, wherein a printing zone is sized to facilitate being irradiated by one or more, preferably at least two, excitation light projections to at least partially form a three-dimensional printed object within the volume of photopolymerizable composition in the printing zone, and

directing the one or more, preferably at least two, excitation light projections into each printing zone to selectively photopolymerize the photopolymerizable composition at one or more selected locations in the printing zone to at least partially form a three-dimensional object in a printing zone.

A cartridge included in a method in accordance with the invention can optionally further include one or more of any of the cartridge features described herein.

Methods in accordance with the present invention can optionally further include a step comprising post-treating separated objects. Examples of post-treatments are described below.

Preferably a photopolymerizable composition for use in the cartridges, systems, and methods described herein displays non-Newtonian rheological behavior such that the object formed in the photopolymerizable composition within the printing zone remains at a fixed position or is minimally displaced in the unpolymerized photopolymerizable composition during formation, directing the excitation light through the at least an optically transparent window into the printing zone to selectively photopolymerize the photopolymerizable composition in the printing zone without support structures to form a printed object, wherein the printed object remains at a fixed position or is minimally displaced in the unpolymerized photopolymerizable composition during formation.

More preferably the photopolymerizable composition for use in the cartridges, systems, and methods described herein comprises a photohardenable component and a photoswitchable photoinitiator, wherein the photoswitchable photoinitiator is activatable by exposure to light having a first wavelength and light having a second wavelength to induce a crosslinking or polymerization reaction in the photohardenable component, wherein the first and second wavelengths are different, wherein the photopolymerizable composition displays non-Newtonian rheological behavior. Optionally, the photopolymerizable composition can further include a coinitiator and/or a sensitizer. A sensitizer can create the excited state of the photoswitchable photoinitiator via absorbing light and transferring energy to the photoswitchable photoinitiator. The photopolymerizable composition can optionally include a synergist.

In the systems and methods in accordance with the present invention, the selection of wavelength(s) of the excitation light for the excitation light projections is preferably made taking into account the photopolymerizable composition and hardening mechanism being used.

For example, for photopolymerizable compositions that are hardenable via a hardening mechanism that involves a single wavelength of excitation light, the wavelength of the two or more excitation light projections can be the same. Optionally in such case, at least one of the two or more excitation light projections can include a different wavelength light, for example for inhibiting undesired hardening of the photopolymerizable composition.

In cases where a photopolymerizable composition is hardenable via a hardening mechanism that involves more than wavelengths of excitation light, the wavelength of at least two of the two or more excitation light projections will be selected for projecting excitation light with appropriate wavelengths for the hardening mechanism. Optionally an additional wavelength light can also be used to inhibit undesired hardening of the photopolymerizable composition.

Systems and methods in accordance with the present invention can further include one or more control systems for controlling at least one of: the selective projection of the one or more, preferably at least two, excitation light projections into one or more of the printing zones at one or more selected locations, dispensing the photopolymerizable composition into the cartridge, discharging unpolymerized photopolymerizable composition and one or more printed three-dimensional objects from the cartridge, and, if an entry port and/or exit port is included in at least one cartridge wall, opening and closing thereof.

Optical systems included in the systems and methods described herein are typically used in combination with a computer and software. Software can be used to coordinate generation of optical projections (e.g., point illuminations, line illuminations, a two-dimensional pattern, or a light sheet) from their respective optical projection system at each position along the projection direction of each so that the part is developed plane by plane. The planar face of an optical projection can be orthogonal to its projection direction into photopolymerizable composition. When two optical projections are projected into the printing zone, the projection directions of the two projections are preferably orthogonal to each other. Selection of computer controls and software is within the skill of the person of ordinary skill in the relevant art. Other components can also optionally be included or used with the system.

Systems in accordance with the present invention can optionally further include one or more inspection units or zones (which may also be referred to herein as regions) that are preferably not light tight. An inspection unit can facilitate visualization and/or characterization (e.g., measurement, flaw-detection, etc.) of printed objects. An inspection unit or zone can be situated to permit inspection of printed parts after formation, e.g., prior to separation (if included), after separation (if included), and/or after post-treatment (if included). Optionally light may be projected into inspection zone for purposes of, e.g., visualization or measurement. Optionally ultrasound may be projected into an inspection zone for purposes of, e.g., visualization or measurement.

Methods in accordance with the present invention can optionally further include one or more inspection steps. An inspection step can be included in a method described herein to permit inspection of printed parts after formation, e.g., prior to a separating step (if included), after a separating step (if included), and/or after a post-treatment step (if included).

Preferred systems and methods in accordance with the present invention are particularly useful for printing three-dimensional (3D) objects from photopolymerizable compositions that demonstrate non-Newtonian behavior and which can be solidified at volumetric positions impinged upon by two or more excitation light projections to form a printed object without requiring the addition of support structures and with increased ease of separating from unpolymerized photopolymerizable composition. Support structures are typically required by most 3D printing technologies involving vat polymerization technologies to stabilize the part during printing or to allow printing of thin or fragile overhanging portions of the part; after printing, post-processing is required to remove the support structures, which can damage or leave marks on the printed part. Avoiding addition of support structures would advantageously simplify post-processing of printed parts and improve part surface quality. Non-Newtonian behavior of the photopolymerizable composition can additionally simplify separation of the part from unpolymerized polymerizable liquid because upon application of stress, the apparent viscosity of the non-Newtonian photopolymerizable composition drops to a lower value (e.g., the steady shear viscosity) than the static value (e.g., zero shear viscosity or yield stress) allowing the unpolymerized polymerizable liquid to more easily flow off and separate from the part.

Heating of the unpolymerized photopolymerizable composition in addition to applying stress may further enhance the ability of the liquid to flow off and separate from the part.

Systems and methods in accordance with the present invention advantageously further do not require adhering the object being printed to a fixed substrate (e.g., build plate) at the beginning of the printing process avoiding a post-processing step of separating the printed object from the fixed substrate.

In systems and methods in accordance with aspects of the invention including at least two excitation light projections, optionally one or more of the two excitation light projections can comprise a light sheet, which may be constructed by means known in the art including, for example, but not limited to: Powell lens, galvanometer, polygon scanning mirror.

In systems and methods in accordance aspects of the invention including at least two excitation light projections, it can be preferred for at least two of the at least two excitation light projections to be directed into the volume in directions perpendicular to each other.

Methods in accordance with the present invention may further include pretreating the photopolymerizable composition prior to introduction into the cartridge, for example, to remove bubbles and any suspended debris. Non-limiting examples of such pretreating include degassing, centrifugation, filtration. A pretreatment module or region can optionally further be included in a system described herein.

The foregoing, and other aspects and embodiments described herein and contemplated by this disclosure all constitute embodiments of the present invention.

It should be appreciated by those persons having ordinary skill in the art(s) to which the present invention relates that any of the features described herein in respect of any particular aspect and/or embodiment of the present invention can be combined with one or more of any of the other features of any other aspects and/or embodiments of the present invention described herein, with modifications as appropriate to ensure compatibility of the combinations. Such combinations are considered to be part of the present invention contemplated by this disclosure.

It is to be understood that both the foregoing general description and the following detailed description are exemplary and explanatory only and are not restrictive of the invention as claimed.

Other embodiments will be apparent to those skilled in the art from consideration of the description and drawings, from the claims, and from practice of the invention disclosed herein.

### BRIEF DESCRIPTION OF THE DRAWINGS

In the drawings,

FIG. 1A depicts an example of dimensional parameters useful for determining a preferred cartridge size. Coordinate axes for the drawing are also shown.

FIG. 1B depicts an example of an example of dimensional parameters useful for determining a preferred cartridge size. Coordinate axes for the drawing are also shown.

FIG. 1C depicts a legend for FIGS. 1A and 1B.

FIG. 2A depicts an example of dimensional parameters useful for determining a preferred cartridge size. Coordinate axes for the drawing are also shown.

FIG. 2B depicts an example of a dimensional parameters for a cartridge including multiple printing zones, one of which is outlined and labeled as “1 Bounding Box”. Coordinate axes for the drawing are also shown.

FIG. 2C depicts a legend for FIGS. 2A and 2B.

FIG. 3 depicts an example of a cartridge including five printing zones.

FIG. 4 depicts an example of the system including two optical systems positioned to direct excitation light projections into a printing zone. (Other optical systems associated with the other printing zones are not shown.)

The attached figures are simplified representations presented for purposes of illustration only; the actual structures may differ in numerous respects, particularly including the relative scale of the articles depicted and aspects thereof.

For a better understanding of the present invention, together with other advantages and capabilities thereof, reference is made to the following disclosure and appended claims in connection with the above-described drawings.

### DETAILED DESCRIPTION OF THE INVENTION

Various aspects and embodiments of the present inventions will be further described in the following detailed description.

The present invention includes cartridges, systems and methods for printing one or more three-dimensional objects.

Volumetric 3D printing includes selective hardening of a three dimensional pattern (e.g., an object or part) in a volume of photohardenable (hardenable) composition via the application of one or more light projections. Preferably the cartridge includes an optically transparent and optically flat region to accommodate directing each projection of light into the volume of the photohardenable (hardenable) composition to facilitate optically addressing the photohardenable composition. A cartridge in accordance with the present invention, and systems and methods including same can sized to accommodate printing multiple objects in a single cartridge which advantageously can improve overall printing efficiency.

The inventions described herein can also facilitate reduction of labor required for 3D printing by being readily adaptable for filling, handling, printing, emptying, and cleaning autonomously and efficiently in contrast to volumetric 3D printing techniques that rely on cuvettes or vials which must be filled, emptied, and cleaned by hand for each print, which is a slow and arduous process.

In accordance with one aspect of the present invention, there is provided a cartridge for printing one or more three-dimensional objects, the cartridge being configured to contain a volume of a photopolymerizable composition, the cartridge including side walls, preferably four, attached to a bottom wall to define a volume space for containing the volume, the cartridge being configured for including one or more printing zones, wherein a printing zone is sized to facilitate being irradiated by one or more, preferably at least two, excitation light projections to at least partially form a three-dimensional printed object within the volume of photopolymerizable composition in the printing zone.

A cartridge can be open. An open cartridge can further include a cover, which can be removable, for closing the cartridge. A cartridge can be closed, including a top wall opposite the bottom wall, in such case at least one of the walls can include at least one port in at least one of the walls for facilitating the introduction and/or removal of unpolymerized photopolymerizable composition and/or removal of one or more three-dimensional objects from the cartridge.

In accordance with another aspect of the present invention, there is provided a cartridge for printing one or more three-dimensional objects, the cartridge being configured to contain a volume of a photopolymerizable composition, the cartridge including opposed end walls and including at least one port in at least one end wall of the cartridge for facilitating the introduction and/or removal of unpolymerized photopolymerizable composition and/or removal of one or more three-dimensional objects from the cartridge, the cartridge being configured for including one or more printing zones, wherein a printing zone is sized to facilitate being irradiated by one or more, preferably at least two, excitation light projections to at least partially form a three-dimensional printed object within the volume of photopolymerizable composition in the printing zone.

It may be desirable for an entire cartridge described herein to be optically transparent.

Alternatively, a cartridge described herein can include one or more optically transparent regions associated with a printing zone to facilitate directing excitation light projections into the printing zone through the one or more optically transparent regions. For example, two optically transparent regions or sides can be included in a cartridge when a printing zone is addressed by two optical systems. When three optical systems address a printing zone, three optically transparent regions or sides can be included in a cartridge. Additional optically transparent regions or sides can optionally be included.

Preferably optically transparent region(s) of a cartridge is (are) also optically flat.

A cartridge can include a first port for the introduction of the photopolymerizable composition into the cartridge and a second port for the removal of unpolymerized photopolymerizable composition and/or one or more three-dimensional objects from the cartridge. Inclusion of two ports, for example, can be also desirable for purposes of removal of the contents of a cartridge after printing. For example, two ports included at opposite end walls of a cartridge can facilitate applying pressure (e.g., by pumping air) or pumping a fluid into the cartridge through one port to transport the contents toward and through the exit port thereby removing/discharging the contents out of the cartridge through the second port.

A printing zone in a cartridge described herein preferably has dimensions that are determined taking into consideration the dimensions of the object to be printed, the numerical aperture characteristics of the projected light projections, the refractive index of the photopolymerizable composition (or a suitable alternative).

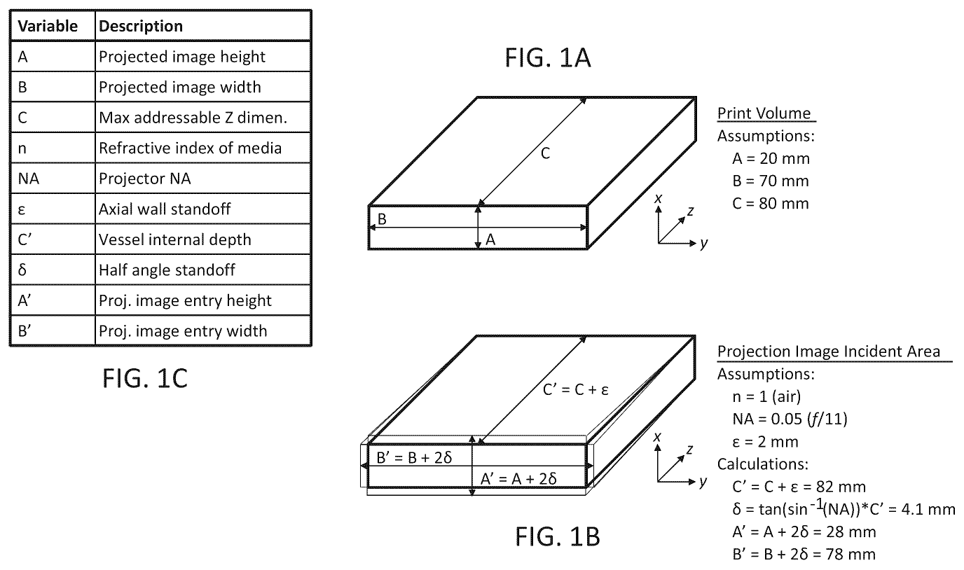

FIG. 1A depicts a diagram showing an example of the dimensions of a projected optical image: the projected image height, A; the projected image width, B; and the maximum addressable Z-dimension, C for printing. In the depicted example, the assumed values A=20 nm, B=70 nm, and C=80 nm. These values are exemplary only and other values may be found to be suitable.

FIG. 1B depicts a diagram showing an example of the dimensions of a projection image incident area superposed over the projected optical image dimensions shown in FIG. 1A and the calculations for determining the dimensions of projected image incident area. Two times the half angle standoff δ is used to determine the maximum projected dimensions of an optical system projection for one printing zone. The projected image entry height is represented by A′; the projected image entry width is represented by B′; the furthest (from incident face) projection plane depth is represented by C′; NA is the numerical aperture of the projection under consideration; and & is a distance chosen to separate the printing zone from the front and back walls of the vessel. These values are calculated using the following equations:

C′=C+ε

δ=tan(sin⁻¹(NA))*C′

A′=A+2δ

B′=B+2δ

wherein:

n=refractive index of the media, e.g., photohardenable composition

NA=the numerical aperture of the projector

ε=axial wall standoff

δ=half angle standoff

### In FIG. 1B:

The following Projection Image Incident Area assumptions are used in calculating A′, B′ and C′ in FIG. 1B:

n=1 (air)

NA=0.05 (f/11)

ε=2 mm

### Calculations:

C′=C+ε=82 mm

δ=tan(sin⁻¹(NA))*C′=4.1 mm

A′=A+2δ=28 mm

B′=B+2δ=78 mm

The values provided in FIG. 1B for NA and ε here are exemplary only and other values may be suitable. It should be noted that this same analysis may be carried out for each of the multiple optical projections into the printing volume, in the case that their dimensions and numerical apertures differ, and that the largest corresponding values of δ be selected.

FIG. 1C is a legend describing the variables included in FIGS. 1A and 1B.

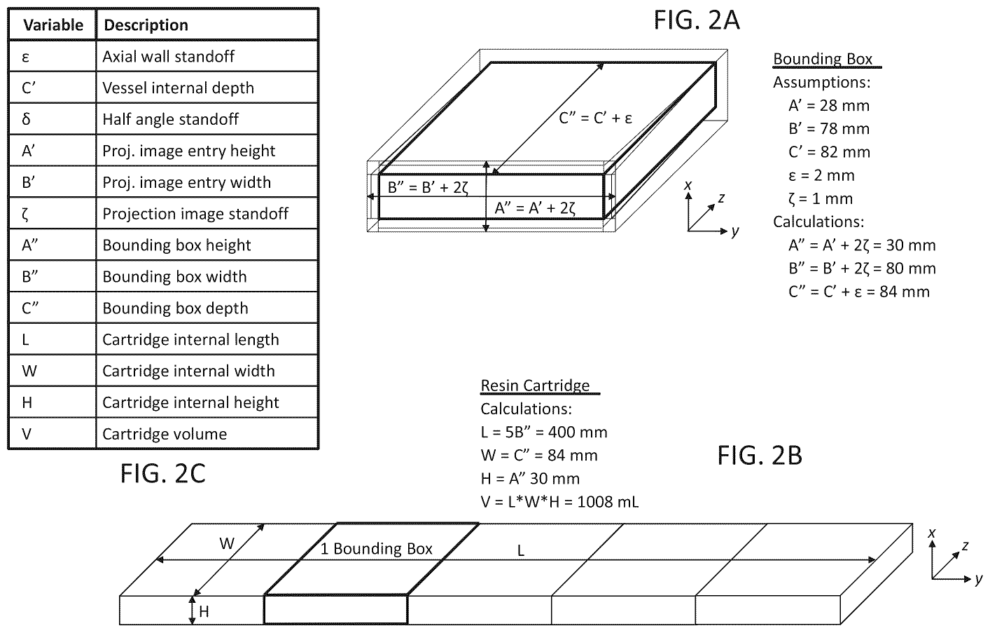

FIG. 2A depicts a diagram showing an example of the dimensions of a printing zone (referred to in the FIG. as “Bounding Box”) superposed over the projection image incident area dimensions shown in FIG. 1B and the calculations for determining the printing zone (referred to in the FIG. as “Bounding Box”) dimensions. The Bounding Box height is represented by A″; the Bounding Box width is represented by B″; the Bounding Box depth is represented by C″; and λ is a distance chosen to separate the printing zone from adjacent printing zone(s). These values are calculated using the following equations:

A″=A′+2ζ

B″=B′+2ζ

C″=C′+ε

wherein:

NA=the numerical aperture of the projector

ε=axial wall standoff

C′=cartridge internal depth

δ=half angle standoff

A′=projected image entry height

B′=projected image entry width

ζ=projection image standoff

A″=bounding box height

B″=bounding box width

C″=bounding box depth

L=cartridge internal length

W=cartridge internal width

H=cartridge internal height

V=cartridge volume

n=refractive index of the media, e.g., photohardenable composition

### In FIG. 2A:

The following Bounding Box Assumptions are used in calculating A″, B″, and C″ for FIG. 2B:

A′=28 mm

B′=78 mm

C′=82 mm

ε=2 mm

ζ=1 mm

The value provided here for ζ is exemplary only and other values may be suitable.

### Calculations:

A″=A′+2ζ=30 mm

B″=B′+2ζ=80 mm

C″=C′+ε=84 mm

FIG. 2B depicts an example of a cartridge designed to include multiple printing zones (referred to in the FIG. as “Bounding Box”). As depicted, the cartridge includes five (5) printing zones. The dimensions of the depicted cartridge (including five printing zones) for the values shown in FIGS. 1A, 1B, 1C, and 2A are: Cartridge internal length is represented by L; cartridge internal width is represented by W; and cartridge internal height is represented by H. Cartridge internal length takes into account the selected number of printing zones to be included in the cartridge. The calculated internal volume of the cartridge is the product of L×W×H.

FIG. 2C is a legend describing the variables included in FIGS. 2A and 2B.

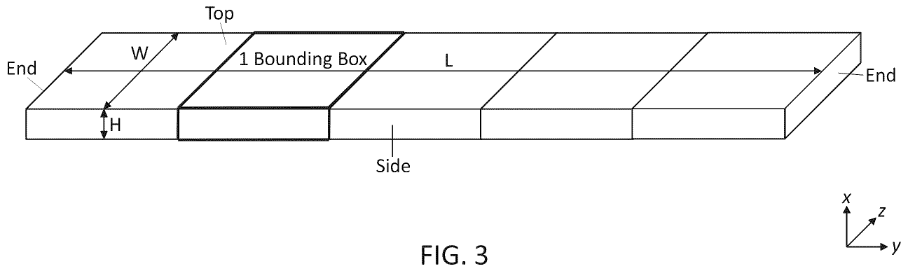

FIG. 3 depicts an example of a cartridge including five printing zone and identifies the top wall, the opposed end walls. The bottom wall opposite the top wall and the side wall opposite the labeled side wall are not shown. It can be desirable for optical projections to be irradiated into a printing zone through one or more of a top wall, bottom wall, and either side wall.

Preferably, when more than one printing zone is included in a cartridge to accommodate the formation of a plurality of objects in the same cartridge, the printing zones are sized to prevent objects printed in adjacent printing zones from touching each other during printing.

Optionally, a partition can be included between printing zones to provide further protection against unwanted polymerization in an adjacent printing zone when multiple printing zones are included in a cartridge. When included, it can be desirable for any such partitions to be removable to facilitate emptying a cartridge after printing.

Optionally, a movable partition can be included to facilitate variable volume of the printing zone(s). Optionally, a movable partition may translate during addition (filling) of the cartridge with photohardenable composition and/or emptying from the cartridge of photohardenable composition and one or more three dimensional objects. Optionally fluid and/or air pressure may be used to facilitate movement of the partition.

A cartridge preferably has a uniform cross-section over its length dimension.

A cartridge can have a circular or oval cross-section.

A cartridge can have a polygonal cross-section.

A cartridge preferably has a rectangular or square cross-section.

Optionally a cartridge has an oblong or other elongated shape. Other shapes may also be useful.

A printing zone is preferably configured to facilitate directing one or more, preferably at least two, excitation light projections into a printing zone.

To facilitate directing excitation projections into a printing zone, a printing zone can include one or more optically transparent regions.

Preferably a cartridge includes one or more optically transparent regions positioned for directing the excitation light projection(s) or passage of the excitation light projections into a printing zone in the cartridge. As mentioned above, optionally, the entire cartridge can be optically transparent, all sides of the printing zone can be optically transparent. For an open cartridge, if a cover, which can be removable, is included, it may also be desirable for the cover to be optically transparent.

A cartridge can be constructed from a material comprising, for example, but not limited to, glass, quartz, fluoropolymers (e.g., Teflon FEP, Teflon AF, Teflon PFA), cyclic olefin copolymers, polymethyl methacrylate (PMMA), polynorbornene, sapphire, or transparent ceramic. Other materials with appropriate hardness that are optically transparent and optically flat may also be suitable.

It can be desirable for a cartridge in accordance with the invention to comprises flat, straight sides that meet at 90° angles.

Preferably a cartridge has a rectangular prism shape. In such case, the rectangular prism shaped cartridge preferably has a uniform cross-section over its longest dimension.

A cartridge in accordance with the present invention (without regard to a port included in a wall or side thereof, if included) can be a one-piece unit or can be constructed from two or more pieces. For example, a cartridge including more than one piece can include side or wall components that are fused together at the edges thereof to form a three-dimensional cartridge unit. Alternatively, the side or wall components can be held together by a frame to form a three-dimensional rectangle. Other construction options may also be suitable.

When a port is included, it is preferably included in a wall other than one through which excitation light will be directed into the volume.

Optionally, one or more of the walls or sides of a cartridge, or the entire cartridge, can be coated. For example, without limitation, one or more sides can include an anti-reflection coating, a mechanically reinforcing coating, a chemical resistance coating, etc. Optionally, one or more sides can include a coating on its internal surface for enhancing the cleanability thereof of the cartridge after it is emptied.

Preferably a cartridge is reusable.

In accordance with another aspect of the present invention, there is provided a system for printing one or more three-dimensional objects, the system comprising a cartridge described herein, and one or more optical systems wherein an optical system is positioned or positionable to selectively direct one or more, preferably at least two, excitation light projections into a single printing zone.

Preferably the cartridge is removable or replaceable.

Optionally a system can include robotics (e.g., a robotic arm or gantry with a grasping mechanism) that can be used to remove a removable/replaceable cartridge from, or insert a cartridge into, a system. Other suitable means can be used in the alternative.

Preferably, at least one of the cartridge and the one or more optical systems is movable with respect to each other.

Preferably the cartridge is reusable. For example, a cartridge can be emptied, clean, refilled, and reused for printing.

A system can further include a separator unit for receiving unpolymerized photopolymerizable composition and one or more printed three-dimensional objects removed from the cartridge through the port. The separator unit is configured for separating any printed three-dimensional objects from unpolymerized photopolymerizable liquid included in the discharged contents. A separator unit can include a first discharge port for discharging any separated printed objects from the separator. A separator unit can also include a second discharge port for discharging the separated unpolymerized photopolymerizable liquid from the separator unit. Optionally the separated unpolymerized photopolymerizable liquid can be recycled.

A separator unit is optionally sealed to prevent introduction of air or oxygen into the unit during separation.

A separator unit can mechanically separate any printed objects from the unpolymerized photopolymerizable liquid in the contents removed from the cartridge after printing. Examples of techniques for mechanically separating print objects from unpolymerized photopolymerizable liquid in the discharged contents include, but are not limited to, screening techniques, use of a scoop or claw to extract any printed objects from the discharged contents, a cyclonic separator, a spiral separator, a compressed gas curtain (e.g., air knife); and a combination of two or more techniques. Heating of the unpolymerized photopolymerizable liquid in addition to applying stress may further enhance the ability of the liquid to flow off and separate from the part.

Optionally, the second discharge port of the separator unit is adapted for connection to a return line or recirculation loop for recirculating the separated unpolymerized photopolymerizable composition to the source of the photopolymerizable composition to be pumped into the cartridge.

The separated unpolymerized photopolymerizable liquid can optionally be treated or reconditioned after separation from any printed objects. Examples of such treatments include, without limitation, cleaning/purification, filtering, degassing, centrifugation, solvent, or monomer addition.

The printed objects collected from the separator unit can optionally be post-treated.

Examples of post-treatments include, but are not limited to, washing, post-curing (e.g., by heat, non-ionizing radiation, ionizing radiation, humidity, pressure, or simultaneous or sequential combinations of techniques), metrology, labelling or tagging with a trackable device (e.g., barcode, QR code, RFID tag), freeze-dry processing, critical point drying, sterilization (e.g., by UV, X-ray, e-beam, ethylene oxide, ozone), and packaging.

Optionally, a system can further include a post-treatment unit or region for carrying out one or more selected post-treatment steps on printed objects after isolation from unpolymerized photopolymerizable liquid. A post-treatment unit or region can be configured for receiving the separated printed objects from the separator unit.

A system can further include a recycling unit in connection with an optional separator unit, if included, for receiving the separated unpolymerized photopolymerizable composition. The recycling unit can recondition the separated unpolymerized photopolymerizable composition before recirculating it for dispensing it to the cartridge. Preferably a recycling unit is configured to recondition the separated unpolymerized photopolymerizable composition before recirculating it to a reservoir of photopolymerizable composition.

The system can optionally further include a recirculation loop in connection with the second discharge port of an optional separator, if included, or in connection with an optional recycling unit, if included, for recirculating the separated unpolymerized photopolymerizable composition to a reservoir of photopolymerizable composition for future use.

The system can further include a control system for controlling, for example, projection of excitation light projections into one or more of the printing zones and other aspects of the printing process and system.

A system can further optionally include a post-treatment unit or region.

A system can further optionally include a one or more inspection units or regions for inspecting printed objects after formation.

A system can further include one or more optical systems positioned or positionable to selectively direct one or more, preferably at least two, excitation light projections into a printing zone, preferably though an optically transparent region of the printing zone.

Depending on the hardening mechanism of the photohardenable composition, one or more separate optical systems positioned or positionable to selectively direct one or more excitation light projections through the one or more optically transparent regions of the cartridge into a printing zone can be preferred.

Optionally, a single optical system including two lights sources configured to project two excitation light projections into the printing zone can be used.

Depending upon the photopolymerizable mechanism selected to print a part, the one or more excitation light projections can include the same wavelength or different wavelengths.

Multiple optical systems may be provided to address the same printing zone simultaneously or sequentially, using the same or different excitation lights. For example, two or more optical systems may be positioned on opposite or adjacent sides of the printing zone, or at any other location relative to each other. When multiple optical systems are used to address a single printing zone, excitation light from each optical system may be fully intersecting, partially intersecting, or nonintersecting. It may be desirable for two or more of the optical excitation projections from multiple optical systems to be directed into a printing zone in directions that are orthogonal to each other. It can be desirable, for example, for the orthogonal projections to include a light sheet and an optical image.

Optionally, the at least one optical system used with or included in the system can be movable in relation to the printing zone such that one or more, preferably at least two, excitation light projections can be irradiated into the printing zone from one or more sides of the printing zone (e.g., from the top, one side, both sides, the bottom, or any combination including two or more sides). If a movable optical system is to be used, the printing zone will include transparent portions or regions to accommodate irradiation of excitation light into the printing zone from one or more sides. For example, each side or surface of the printing zone through which the excitation light is to be irradiated will be optically transparent or at least include an optically transparent region through which the excitation light can pass.

By way of example, and without limitation, the cartridge may be translated along a first direction (“z”) to facilitate printing or the projections may translate and the cartridge remain fixed in place. The projections may also remain fixed via use of variable focus lenses or 2D scanning optics. An object is formed (or “drawn”) by sweeping the intersection of a first light projection (e.g., a lightsheet) and a second light projection (e.g., an image) through a first printing volume, wherein the illuminations are contained by the printing zone (or bounding box), and wherein hardening occurs at each intersection. The cartridge may subsequently be moved and a second part drawn within a second bounding box, and so on.

Optionally, the excitation light can be temporally and/or spatially modulated. Optionally, the intensity of the excitation light can be modulated.

Optionally, two or more optical systems direct excitation light of multiple wavelengths through two or more optically transparent regions into separate printing zones. Preferably, at least one optical system directing excitation light of a first wavelength can be modulated. Preferably, at least one optical system directing excitation light of a second wavelength is movable in relation to the printing zone.

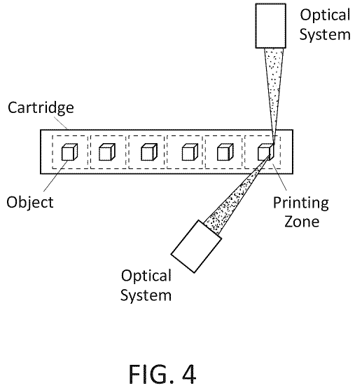

FIG. 4 depicts an example of a systems of the invention including two optical systems positioned to direct excitation light projections into a printing zone.

Spatially modulated excitation light can be created by known spatial modulation techniques, including, for example, a liquid crystal display (LCD), a digital micromirror display (DMD), a microLED array, a grating light valve, a galvanometer scanner, or a polygon mirror scanner. Other known spatial modulation techniques can be readily identifiable by those skilled in the art.

The optical system can be selected to apply continuous excitation light. The optical system can be selected to apply intermittent excitation light. Intermittent excitation can include random on and off application of light or periodic application of light. Examples of periodic application of light includes pulsing. The optical system can be selected to apply a combination of both continuous excitation light and intermittent light, including, for example, an irradiation step that includes the application of intermittent excitation light that is preceded or followed by irradiation with continuous light.

Preferably, the excitation light has a wavelength in the visible or ultraviolet range.

The optical system can be movable in one or more of the x, y, and z directions in relation to a given printing zone.

It can be desirable for a cartridge to include more than one printing zone. Each printing zone will include at least one optically transparent region to facilitate the irradiation of one or more, preferably at least two, excitation light projections into the photopolymerizable liquid in each printing zone. As discussed above, other portions or all of a printing zone can be optically transparent to accommodate at least one the optical system to be used and its movability.

When the system includes more than one printing zone, the system can include one or more optical systems associated with each printing zone. Alternatively, when the system includes more than one printing zone, the system can include one or more optical systems that are movable in relation to at least the locations of the printing zones in the cartridge and repositionable for irradiating excitation light into each of the printing zones, one at a time.

For example, when it is desired to print a plurality of objects in a cartridge, the cartridge includes a number of printing zones corresponding to the number of objects to be printed. In such case, the system can optionally include one or more optical systems (based on the hardening mechanism involved) for each printing zone, or the system can include a single configuration of one or more optical systems, and a first object can be printed in a first printing zone, and the cartridge can be repositioned to align the next printing zone with optical system configuration to print a next part, and this can be repeated until the selected number of objects have been printed.

Depending upon the photopolymerizable mechanism selected to print a part, for example, when two or more excitation light projections are involved, they can include wavelengths that are the same or different.

An excitation light projection is typically generated by a separate optical system in connection with an excitation light source. One or more of the light sources can emit wavelengths that is the same as or different from that of another light source being used.

A preferred optical projection system for projecting optical images comprises a digital micromirror display projection system.

Preferably, the cartridge, optical systems, and/or other optional components of the system are modular and independently removable and/or replaceable.

It can be desirable for the one or more components of the system to be included in a single housing.

Preferably the system is capable of being light tight except for the printing zone to reduce unwanted photopolymerization and any inspection unit or zone that may utilize light as part of an inspection/characterization technique.

Preferably a cartridge and system described herein are capable of being leak tight (also referred to herein as liquid tight) to prevent undesired leakage of the photopolymerizable composition. For example, under leak tight conditions, photopolymerizable composition is retained without loss from leakage.

In use, a cartridge is filled with a photopolymerizable composition to be selectively photopolymerized in the printing zone to form a three-dimensional object.

Optionally, two or more optical systems direct excitation light of multiple wavelengths through two or more optically transparent regions into a printing zone. Preferably, at least one optical system directing excitation light of a first wavelength can be modulated. Preferably, at least one optical system directing excitation light of a second wavelength is movable in relation to the printing zone. FIG. 4 depicts an example of a system of the invention including two optical systems positioned to direct excitation light projections into a printing zone.

The system can optionally include more than one printing zone. Each printing zone will include at least one optically transparent region to facilitate the irradiation of one or more, preferably at least two, excitation light projections into the photopolymerizable composition in each printing zone. As discussed above, other portions or all of a printing zone can be optically transparent to accommodate at least one the optical system to be used and its movability.

When the system includes more than one printing zone, the system can include one or more optical systems associated with each printing zone. Alternatively, when the system includes more than one printing zone, the system can include one or more optical systems that are movable in relation to at least the locations of the printing zones and repositionable for irradiating excitation light into each of the printing zones, one at a time.

A separator unit, if included, is optionally sealed to prevent introduction of air or oxygen into the unit during separation.

Optionally, a system can further include a post-treatment unit or region for carrying out one or more selected post-treatment steps on printed objects after isolation from unpolymerized photopolymerizable composition. A post-treatment unit or region can be configured for receiving the separated printed objects from the separator unit.

The methods described herein preferably include a photopolymerizable composition that displays non-Newtonian rheological behavior and the one or more excitation light projections are selectively directed into the printing zone to selectively photopolymerize the photopolymerizable composition at one or more selected locations in the printing zone to form a printed object without support structures, wherein the printed object remains at a fixed position or is minimally displaced in the unpolymerized photopolymerizable composition during formation.

To permit customization of the 3D printing process to be carried by a system described herein, it may be desirable for a system to be fully or partially modular to accommodate one or more components of a system to be exchanged with one or more replacement components for performing similar respective functions but including features and/or capabilities for achieving the particular customization that is desired. For example, a cartridge could be replaced by a larger or smaller cartridge to accommodate different size or capacity, a cartridge could be replaced by multiple cartridges, a cartridge could be replaced by one including one or more optically transparent regions configured to accommodate the one or more optical systems selected for use; an optical system could be replaced by one or more systems with different excitation wavelength and/or power capabilities; a separator, if included in the system, could be replaced by a separator that achieves separation of printed parts from unpolymerized photopolymerizable composition by a particular technique; a post-treatment component, if included, could be selected based on the desired post-treatment steps selected.

Optionally, a cartridge and/or optical systems (whether internal to the printing unit or external thereto) can further be adapted to be movable, for example, in one or more of x, y, and z directions for selectively directing excitation light projections to one or more selected locations in a printing zone during printing or forming 3D objects. Such movement can be achieved with an x, y, z-translation stage (not shown). Optionally, as discussed herein, the unpolymerized photopolymerizable composition from which the printed objects are separated can be reused or recycled.

A system can include separate modules in operable connection for 3D-printing objects having a selected design in a volume of photopolymerizable composition included in the printing zone of a cartridge, discharging the content of the cartridge into a separator to separate the printed objects from the unpolymerized photopolymerizable composition, and transporting the separated printing objects into a post-treatment unit or region of the system for carrying out one or more desired post-treatment steps.

Alternatively, the system can comprise a system in which one or more of the components are included in a unitary housing.

In accordance with yet another aspect of the present invention, there is provided a method of printing one or more three-dimensional objects, the method comprising: providing a volume of a photopolymerizable composition in a cartridge described herein, and directing one or more, preferably at least two, excitation light projections into each printing zone to selectively photopolymerize the photopolymerizable composition at one or more selected locations in the printing zone to at least partially form a three-dimensional printed object within the volume of photopolymerizable composition in the printing zone.

The method can further include separating any printed objects from unpolymerized photopolymerizable composition included in contents removed from the cartridge after printing.

Optionally, the method is carried out in a light tight environment except for the printing zone to reduce unwanted photopolymerization and any inspection unit or zone that may utilize light as part of an inspection/characterization technique.

Optionally, the method further comprises recycling the separated unpolymerized photopolymerizable composition from the removed contents.

Optionally, the method can further include treating or conditioning separated unpolymerized photopolymerizable composition after separation from any printed objects. Examples of such treatments include, without limitation, cleaning/purification, filtering, degassing, centrifugation, solvent, or monomer addition.

A method can further include post-treating the at least partially formed three-dimensional objects after separation from unpolymerized photopolymerizable composition.

For example, a method can further include and one or more of washing/cleaning the separated objects; post-curing (e.g., by heat or UV) the at least partially formed three-dimensional objects after separation from unpolymerized photopolymerizable composition; inspecting the at least partially formed three-dimensional objects; packaging the objects, etc.

Optionally the method is carried out in an inert atmosphere.

Systems described herein may be useful in carrying out the various methods described herein.

In one example of the method, 1) a resin or photohardenable composition is photocured without support structures so that the part is suspended therein; 2) the resin or photohardenable composition is thixotropic (shear-thinning) or has a yield stress, such that during the curing operation the part remains fixed in space or undergoes a minimal amount of displacement; 3) upon application of pressure or other force cured part or parts are moved out of the cartridge; 4) the parts are separated from the unpolymerized photohardenable composition (which may also be referred to herein as resin); and 5) the unpolymerized photohardenable composition is optionally recycled.

The method of the present invention can produce one or more printed objects utilizing light-induced solidification of a photopolymerizable composition.

Preferably the photopolymerizable composition displays non-Newtonian rheological behavior such that the object formed in the photopolymerizable composition within the printing zone remains at a fixed position or is minimally displaced in the unpolymerized photopolymerizable composition during formation, directing the excitation light through the at least an optically transparent window into the printing zone to selectively photopolymerize the photopolymerizable composition in the printing zone without support structures to form a printed object, wherein the printed object remains at a fixed position or is minimally displaced in the unpolymerized photopolymerizable composition during formation.

Examples of such non-Newtonian rheological behavior include pseudoplastic fluid, yield pseudoplastic, or Bingham plastic. This behavior may be due to the combination of reactive components in the resin (monomers and oligomers) or imparted by a nonreactive additive (thixotrope, rheology modifier). Formulation of photopolymerizable components that display non-Newtonian behavior is within the skill of skilled artisan in the relevant art. Examples include a formulation of a photopolymerizable composition for use in the present method includes 86 parts GENOMER 4259 (an aliphatic urethane acrylate), 14 parts N,N-dimethylacrylamide, 13.3 parts 60 wt % nanoparticle dispersion in N,N-dimethylacrylamide, 2 parts Rheobyk 410 thixotrope, 0.5 parts Bis(2,6-difluoro-3-(1-hydropyrrol-1-yl)phenyl)titanocene photoinitiator, 0.001 parts 2,2,6,6-Tetramethyl-1-piperidinyloxy free radical inhibitor. An additional example of a formulation of a photopolymerizable composition for use in the present method includes 90 parts GENOMER 4247 (an aliphatic urethane methacrylate), 10 parts N,N-dimethylacrylamide, 1.2 parts Crystasense HP-5 thixotrope (a polyalkyleneoxy terminated polyamide), 0.20 parts butyryl choline butyltriphenylborate, and 0.005 parts of a 1′-benzyl-3′,3′-dimethyl-8-iodo-7-methoxy-6-nitrobenzospiropyran photoswitchable photoinitiator.

For photopolymerizable compositions that display non-Newtonian rheological behavior, preferred steady shear viscosities are less than 10,000 cP and most preferably less than 1,000 cP. (Steady shear viscosity refers to the viscosity after the thixotrope network has broken up.)

Preferred photopolymerizable compositions included in methods and/or systems described herein comprise a photohardenable component, a photoswitchable photoinitiator and a coinitiator, wherein the photoswitchable photoinitiator is activatable by exposure to light having a first wavelength and light having a second wavelength to induce a crosslinking or polymerization reaction in the photohardenable component, wherein the first and second wavelengths are different, wherein the photopolymerizable composition displays non-Newtonian rheological behavior.

Additional information that may be helpful concerning the components/steps included of this method can be found elsewhere herein in discussion of other aspects of the present invention.

Examples of sources of the excitation light source for use in the methods described herein include laser diodes, such as those available commercially, light emitting diodes, DMD projection systems, micro-LED arrays, vertical cavity lasers (VCLs). In some embodiments, the excitation radiation source (e.g., the light source) is a light-emitting diode (LED).

Systems and methods in accordance with the present invention are particularly useful for printing three-dimensional (3D) objects from photopolymerizable compositions that demonstrate non-Newtonian behavior and which can be solidified at volumetric positions impinged upon by excitation light to form a printed object without requiring the addition of support structures. Support structures are typically required by most 3D printing technologies involving vat polymerization technologies to stabilize the part during printing or to allow printing of thin or fragile overhanging portions of the part; after printing, post-processing is required to remove the support structures, which can damage or leave marks on the printed part. Avoiding addition of support structures would advantageously simplify post-processing of printed parts.

Systems and methods in accordance with the present invention are particularly useful for printing three-dimensional (3D) objects from photopolymerizable compositions that demonstrate non-Newtonian behavior and which can be solidified at volumetric positions impinged upon by excitation light to form a printed object which advantageously simplifies separation of the part from unpolymerized polymerizable liquid because upon application of stress, the apparent viscosity of the non-Newtonian photopolymerizable composition drops to a lower value (e.g., the steady shear viscosity) than the static value (e.g., zero shear viscosity or yield stress) allowing the unpolymerized polymerizable liquid to more easily flow off and separate from the part.

Systems and methods in accordance with the present invention advantageously further do not require adhering the object being printed to a fixed substrate (e.g., build plate) at the beginning of the printing process avoiding a post-processing step of separating the printed object from the fixed substrate.

Post-processing steps of removing support structures and/or removing the printed object from a fixed substrate add labor (e.g., manual removal), waste (discarded support structures), and reduce throughput (a build plate cannot be reused until the printed object is removed), all of which add cost to the process.

Optionally, depending upon the oxygen sensitivity of the photopolymerizable composition being used, the photopolymerizable composition is purged or sparged with an inert gas before being introduced into a cartridge and is maintained in an inert atmosphere during printing. The source of the photopolymerizable composition and the photopolymerizable composition included in a reservoir used to feed the cartridge can also optionally be purged and maintained under inert conditions before use in the systems and methods of the present invention.

Methods and systems in accordance with the present invention are additionally particularly useful for printing 3D objects from photopolymerizable compositions that demonstrate non-Newtonian behavior and which can be solidified at volumetric positions impinged upon by excitation light at two different wavelengths by dual-color photopolymerization.

Preferably the photopolymerizable composition includes (i) a photopolymerizable component; and (ii) a dual-color photoinitiator (also referred to herein as a photoswitchable photoinitiator) that initiates polymerization of the photopolymerizable component upon simultaneous or sequential excitation by light at two different wavelengths, wherein the photopolymerizable composition demonstrates non-Newtonian behavior.

As discussed herein, a photopolymerizable composition can preferably include: a photopolymerizable component; a dual-color photoinitiator which converts from an inactive (non-initiating) form via excitation light of a first wavelength into an active (initiating) form, wherein subsequent or simultaneous excitation light of a second wavelength absorbed by the active form causes solidification of the photopolymerizable component; and optionally a synergist which in combination facilitates photoinitiation by the dual-color photoinitiator active form via, e.g., electron transfer or hydrogen transfer.

A dual-color photoinitiator or photoswitchable photoinitiator can comprise a photochromic dye. The dual-color photoinitiator preferably spontaneously reverts from active form to inactive form via thermal energy at the ambient temperature (T-type photochromism). Various types of T-type photochromic dyes are known to those skilled in the art, including but not limited to spiropyrans. These dyes function by light activated ring opening to form a merocyanine dye (active form). The active form may subsequently absorb light of a different wavelength to form an excited state of the active form which may subsequently induce photoinitiation, either alone or in combination with a co-initiator or synergist (e.g., amine, thiol, organoborate compounds). Properties important for the selection of a dual-color photoinitiator include absorbance spectra for the inactive and active forms; switching rates for the transitions between both forms; and equilibrium concentration of both forms; and intersystem crossing yield of the excited state of the active form. High intersystem crossing yield of the excited state of the active form is beneficial for producing long-lived triplet excited states which may interact via electron, proton, or energy transfer with a syngerist to induce photoinitiation. An example of a suitable dual-color photoinitiator is 1′-benzyl-3′,3′-dimethyl-8-iodo-7-methoxy-6-nitrobenzospiropyran.

A co-initiator or synergist can comprise, e.g., an amine, a thiol, a thioether, a mercaptan, a silane, an organoborate compound, a diaryliodonium salt, a triarylsulfonium salt. A preferred example of a suitable synergist is butyryl choline butyltriphenylborate.

The photopolymerizable composition may further include additional additives. Examples of such additives include, but are not limited to, thixotropes, oxygen scavengers, etc.

Examples of sources of the excitation light source for use in the methods described herein include laser diodes, such as those available commercially, light emitting diodes, DMD projection systems, micro-LED arrays, vertical cavity lasers (VCLs). In some embodiments, the excitation radiation source (e.g., the light source) is a light-emitting diode (LED).

Systems and methods in accordance with the present invention are additionally particularly useful for printing 3D objects from photopolymerizable compositions that demonstrate non-Newtonian behavior and which can be solidified at volumetric positions impinged upon sequentially or simultaneously by excitation light of two different wavelengths. Most preferably, the photopolymerizable composition contains a dual-color photoinitiator which converts from an inactive form to an active form by excitation from the first wavelength and then is subsequently excited by the second wavelength which induces photoinitiation, either alone or through interaction with a synergist, and subsequent solidification of the photopolymerizable composition.

Preferably the photopolymerizable composition includes (i) a photopolymerizable component; (ii) a dual-color photoinitiator; and (iii) a co-initiator or synergist. More preferably, the photopolymerizable composition demonstrates non-Newtonian behavior.

The first and second wavelengths can be in the ultraviolet, visible, or near-infrared range. Preferably the first wavelength is in the ultraviolet range and the second wavelength is in the visible range.

Examples of photoswitchable photoinitiators useful in photopolymerizable compositions can absorb at about 300 nm to about 550, nm, including, but not limited to, about 300 nm to about 450 nm. Depending upon the absorption spectrum for the particular photoswitchable photoinitiator, the conversion to the second form can be induced by exposure to any source which emits in this range, e.g., lasers, light emitting diodes, mercury lamps. Filters may be used to limit the output wavelengths. A non-limiting example of filtered light includes filtered emission from a mercury arc lamp, etc. The second form of the photoswitchable photoinitiator will preferably absorb in a range of about 450 to 1000 nm and 450 to 850 nm most typically.

Examples of power densities for the first wavelength light include power densities in a range from about 0.01 to about 100,000 W/cm² (inclusive). Examples of power densities for the second wavelength light include power densities in a range from about 0.01 to about 100,000 W/cm² (inclusive).

Examples of exposure energies for the first wavelength light include exposure energies in a range from about 0.001 to about 1,000 mJ/cm² (inclusive). Examples of exposure energies for the second wavelength light include exposure energies in a range from about 0.01 to about 100,000 mJ/cm² (inclusive).

Preferably light of the first wavelength and light of the second wavelength are projected into the volume as separate optical projections. More preferably the light of the first wavelength is directed along a light sheet illumination axis that is orthogonal to the direction in which the projection of the light of the second wavelength is directed into the volume.

Preferably the light of the first wavelength comprises a light sheet. The light sheet can desirably comprise a planar configuration of light with opposed major faces with the major faces being parallel to direction in which the light sheet is directed into the volume.

Preferably the projection of light of the second wavelength comprises an optical image that is perpendicular to the direction in which the optical image is directed or projected into the volume. A digital micromirror device (DMD) is preferably utilized in the projection of the optical image.

In a preferred embodiment, the light sheet is directed into the volume along a light sheet illumination axis and the optical image is directed into the volume along projection or illumination axis, with the light sheet illumination axis and projection axis being orthogonal to each other, with the optical image being orthogonal to the projection axis, such that the light sheet and optical image intersect in a common plane. It is desirable for the intersection of the light sheet and optical image to be coplanar or substantially coplanar.

An optical image can include any optical projection generated by an optical projection system. Examples of optical images include, without limitation, a patterned or unpatterned two-dimensional image, a line of light, or a single point of light. A two-dimensional image can comprise a cross-sectional plane of the three-dimensional image being printed. A two-dimensional image can represent a cross-sectional slice of an object to be printed. Such cross-sectional slice is typically generated using slicing software.

Examples of light sources of the excitation light that may be suitable for use in methods described herein include, by way of example and non-limitation, lasers, laser diodes, light emitting diodes, light-emitting diodes (LEDs), micro-LED arrays, vertical cavity lasers (VCLs), and filtered lamps. Such light sources are commercially available and selection of a suitable light source can be readily made by one of ordinary skill in the relevant art. LEDs of the type such as Phlatlight LEDs available from Luminus for use with DMDs can be preferred. Other suitable light sources may also be useful.

Optionally, the excitation light can be temporally and/or spatially modulated. Optionally, the intensity of the excitation light can be modulated.

Examples of projection devices for use in the methods and systems described herein may include, but are not limited to, a laser projection system, a liquid crystal display (also referred to herein as “LCD”), a spatial light modulator (also referred to herein as “SLM”) (for example, but not limited to, a digital micromirror device (also referred to herein as “DMD”)), a micro-LED array, a vertical cavity laser array (also referred to herein as “VCL”), a Vertical Cavity Surface Emitting Laser array (also referred to herein as “VCSEL”), a liquid crystal on silicon (also referred to herein as “LCoS”) projector, and a scanning laser system. (Light emitting diode is also referred to herein as “LED”).

An optical image projection system can optionally further include one or more optical components (e.g., projection optics, illumination optics, lenses, lens systems, mirrors, prisms, etc.).

Other information that may be useful in connection dual-wavelength photoinitiators and use thereof include U.S. Pat. No. 5,230,986 of Neckers, U.S. Pat. Nos. 4,041,476, 4,078,229, 4,238,840, 4,466,080, 4,471,470, and 4,333,165 to Swainson, U.S. Pat. No. 4,575,330 to Hull, U.S. Pat. No. 10,843,410 of Lippert, et al. for “System And Method For A Three-Dimensional Optical Switch Display (OSD) Device”, each of the foregoing being hereby incorporated herein by reference in its entirety.

Optionally, depending upon the oxygen sensitivity of the photopolymerizable composition being used, the photopolymerizable composition is purged or sparged with an inert gas before being introduced into the closed cartridge and is maintained in an inert atmosphere while in the closed cartridge. The source of the photopolymerizable composition and the photopolymerizable composition included in a reservoir used to feed the closed cartridge is also optionally purged and maintained under inert conditions before use in the systems and methods of the present invention.

The selected dimensions (e.g., height, width, footprint) of the system can also be a consideration for the size, shape, and orientation of the cartridge and other components (e.g., regions, units, modules, etc.) included in the system.

### Non-Limiting Examples of Embodiments of The Disclosure

Embodiment 1 is a cartridge for printing one or more three-dimensional objects, wherein the cartridge is configured to contain a volume of a photopolymerizable composition, the cartridge including side walls, preferably four, attached to a bottom wall to define a volume space for containing the volume, the cartridge being configured for including one or more printing zones, wherein a printing zone is sized to facilitate being irradiated by one or more, preferably at least two, excitation light projections to at least partially form a three-dimensional printed object within the volume of photopolymerizable composition in the printing zone. The cartridge can be open or can optionally include a top wall or cover, which can be removable, opposite the bottom. Optionally at least one of the walls can include at least one openable/closable port for facilitating the introduction and/or removal of unpolymerized photopolymerizable composition and/or removal of one or more three-dimensional objects from the cartridge.
Embodiment 2 is a cartridge for printing one or more three-dimensional objects wherein the cartridge is configured to contain a volume of a photopolymerizable composition, the cartridge including side walls attached to a bottom wall to define a volume space for containing the volume, the cartridge being configured for including one or more printing zones, wherein a printing zone is sized to facilitate being irradiated by one or more, preferably at least two, excitation light projections to at least partially form a three-dimensional printed object within the volume of photopolymerizable composition in the printing zone.
Embodiment 3 is the cartridge of embodiment 1 or 2 wherein the cartridge includes two or more printing zones, and wherein the printing zones are spaced apart from one another such that excitation light projections can be directed into one printing zone to at least partially form the three-dimensional object without triggering photopolymerization of the photopolymerizable composition in an adjacent printing zone.
Embodiment 4 is the cartridge of embodiment 1 or 2 wherein the cartridge includes two or more printing zones, and wherein the printing zones are sized such that three-dimensional objects being at least partially formed in adjacent printing zones do not touch each other during printing.
Embodiment 5 is the cartridge of embodiments 2 wherein the cartridge includes a first port for the introduction of the photopolymerizable composition into the cartridge and a second port for the removal of unpolymerized photopolymerizable composition and/or one or more three-dimensional objects from the cartridge.
Embodiment 6 is the cartridge of embodiment 2 wherein the port is openable and closable.
Embodiment 7 is the cartridge of embodiment 1 or 2 wherein a printing zone has dimensions based on dimensions of the object to be printed, the numerical aperture characteristics of the projected light projections, the refractive index of the photopolymerizable composition (or a suitable alternative).
Embodiment 8 is the cartridge of embodiment 7 wherein the cartridge includes two or more printing zones, and wherein the printing zones are spaced apart from one another such that excitation light projections can be directed into one printing zone to at least partially form the three-dimensional object without triggering photopolymerization of the photopolymerizable composition in an adjacent printing zone.
Embodiment 9 is the cartridge of embodiment 7 wherein the cartridge includes two or more printing zones, and wherein the printing zones are sized such that three-dimensional objects being at least partially formed in adjacent printing zones do not touch each other during printing.
Embodiment 10 is the cartridge of embodiment 3 wherein the printing zones are sized to prevent objects printed in adjacent printing zones from touching each other during printing.
Embodiment 11 is the cartridge of embodiment 9 wherein the printing zones are sized to prevent objects printed in adjacent printing zones from touching each other during printing.
Embodiment 12 is the cartridge of embodiment 1 or 2 wherein the cartridge has a rectangular prism shape.
Embodiment 13 is the cartridge embodiment 1 or 2 wherein the cartridge has a uniform cross-section over its longest dimension.
Embodiment 14 is the cartridge embodiment 12 wherein the cartridge has a uniform cross-section over its longest dimension.
Embodiment 15 is the cartridge embodiment 1 or 2 wherein the cartridge has a rectangular cross-section.
Embodiment 16 is the cartridge of embodiment 1 or 2 wherein the cartridge is optically transparent.
Embodiment 17 is the cartridge of embodiment 12 wherein the cartridge is optically transparent.
Embodiment 18 is the cartridge of embodiment 1 or 2 wherein the cartridge is optically flat.
Embodiment 19 is the cartridge of embodiment 12 wherein the cartridge is optically flat.
Embodiment 20 is the cartridge of embodiment 1 or 2 wherein the cartridge includes one or more optically transparent regions positioned for directing the excitation light projection(s) and passage of the excitation light projections into a printing zone in the cartridge.
Embodiment 21 is the cartridge of embodiment 12 wherein the cartridge includes one or more optically transparent regions positioned for directing the excitation light projection(s) and passage of the excitation light projections into a printing zone in the cartridge.
Embodiment 22 is the cartridge of embodiment 1 or 2 wherein the cartridge comprises flat, straight walls that meet at 90° angles.
Embodiment 23 is the cartridge of embodiment 12 wherein the cartridge comprises flat, straight walls that meet at 90° angles.
Embodiment 24 is the cartridge of embodiment 22 wherein the walls of the cartridge are fused together at the edges thereof to form a three-dimensional rectangle.
Embodiment 25 is the cartridge of embodiment 23 wherein the walls of the cartridge are fused together at the edges thereof.
Embodiment 26 is the cartridge of embodiment 1 or 2 wherein the walls of the cartridge are held together to form a three-dimensional rectangle by a frame.
Embodiment 27 is the cartridge of embodiment 1 or 2 wherein one or more walls of the cartridge include an anti-reflection coating.
Embodiment 28 is the cartridge of embodiment 1 or 2 wherein one or more walls of the cartridge include a mechanically reinforcing coating.
Embodiment 29 is the cartridge of embodiment 1 or 2wherein one or more walls of the cartridge include a chemical resistance coating.
Embodiment 30 is the cartridge of embodiment 1 or 2 wherein one or more walls of the cartridge include a coating on its internal surface for enhancing the cleanability thereof.
Embodiment 31 is a system for printing one or more three-dimensional objects, the system comprising a cartridge for printing one or more three-dimensional objects, the cartridge being configured to contain a volume of a photopolymerizable composition, the cartridge including side walls attached to a bottom wall to define a volume space for containing the volume, the cartridge being configured for including one or more printing zones, wherein a printing zone is sized to facilitate being irradiated by one or more, preferably at least two, excitation light projections to at least partially form a three-dimensional printed object within the volume of photopolymerizable composition in the printing zone, and one or more optical systems wherein an optical system is positioned or positionable to selectively direct one or more, preferably at least two, excitation light projections into a single printing zone.
Embodiment 32 is a system for printing one or more three-dimensional objects, the system comprising a cartridge configured to contain a volume of a photopolymerizable composition, the cartridge including opposed end walls and including at least one port in at least one end wall of the cartridge for facilitating the introduction and/or removal of unpolymerized photopolymerizable composition and/or removal of one or more three-dimensional objects from the cartridge, the cartridge being configured for including one or more printing zones, wherein a printing zone is sized to facilitate being irradiated by one or more, preferably at least two, excitation light projections to at least partially form a three-dimensional printed object within the volume of photopolymerizable composition in the printing zone, and one or more optical systems wherein an optical system is positioned or positionable to selectively direct one or more, preferably at least two, excitation light projections into a single printing zone.
Embodiment 33 is the system of embodiment 31 or 32 wherein at least one of the cartridge and the one or more optical systems is movable with respect to each other.
Embodiment 34 is the system of embodiment 31 or 32 further including a separator unit for receiving the unpolymerized photopolymerizable composition and one or more printed three-dimensional objects removed from the cartridge.
Embodiment 35 is the system of embodiment 31 or 32 wherein the separator unit is capable of separating printed three-dimensional objects from unpolymerized photopolymerizable composition included in the removed contents.
Embodiment 36 is the system of embodiment 34 wherein the separator unit includes a discharge port for discharging any separated printed objects from the separator unit.
Embodiment 37 is the system of embodiment 34 wherein the separator unit includes a discharge port for discharging any separated printed objects from the separator unit.
Embodiment 38 is the system of embodiment 37 wherein the separator unit further includes a second discharge port for discharging the separated unpolymerized photopolymerizable composition from the separator unit.
Embodiment 39 is the system of embodiment 34 further comprising a recycling unit in connection with the separator unit for receiving the separated unpolymerized photopolymerizable composition for recycling.
Embodiment 40 is the system of embodiment 38 wherein the system further includes a recirculation loop in connection with the second discharge port for recirculating the separated unpolymerized photopolymerizable composition to a reservoir of photopolymerizable composition.
Embodiment 41 is the system of embodiment 39 wherein the system further includes a recirculation loop in connection with the recycling unit for recirculating the separated unpolymerized photopolymerizable composition to a reservoir of photopolymerizable composition.
Embodiment 42 is the system of embodiment 39 wherein the recycling unit is configured to recondition the separated unpolymerized photopolymerizable composition before recirculating it to a reservoir of photopolymerizable composition.
Embodiment 43 is the system of embodiment 31 or 32 wherein a single optical system is configured to project one or more, preferably at least two, excitation light projections into one printing zone.
Embodiment 44 is the system of embodiment 31 or 32 wherein the system includes at least two excitation light projections that include the same wavelength.
Embodiment 45 is the system of embodiment 43 wherein the system includes at least two excitation light projections that include the same wavelength.
Embodiment 46 is the system of embodiment 31 or 32 wherein the system includes at least two excitation light projections that include different wavelengths.
Embodiment 47 is the system of embodiment 43 wherein the system includes at least two excitation light projections that include different wavelengths.
Embodiment 48 is the system of embodiment 31 or 32 wherein the cartridge is removable or replaceable.
Embodiment 49 is the system of embodiment 31 wherein the cartridge includes one or more ports in at least one wall, wherein at least one port preferably being openable and closable.
Embodiment 50 is the system of embodiment 31 or 32 wherein an optical system is in connection with one or more excitation light source.
Embodiment 51 is the system of embodiment 31 or 32 wherein an excitation light projection is generated by a separate optical system in connection with an excitation light source.
Embodiment 52 is the system of embodiment 31 or 32 wherein the excitation light projections are generated by separate optical systems in connection excitation light sources emitting different wavelengths.
Embodiment 53 is the system of embodiment 31 or 32 wherein at least one of the optical systems comprises a digital micromirror display projection system.
Embodiment 54 is the system of embodiment 31 or 32 wherein at least one of the optical systems comprises a light sheet generating system.
Embodiment 55 is the system of embodiment 53 further including an optical system comprising a light sheet generating system.
Embodiment 56 is the system of embodiment 55 wherein the digital micromirror display projection system projects a wavelength of light that is different from the wavelength of light projected by the light sheet generating system.
Embodiment 57 is the system of embodiment 31 or 32 further comprising a post-treatment unit or region.
Embodiment 58 is the system of embodiment 31 or 32 further comprising one or more inspection units or regions for inspecting printed objects after formation.
Embodiment 59 is the system of embodiment 31 or 32 wherein the cartridge, optical systems, and other optional components of the system are modular and independently removable and/or replaceable.
Embodiment 60 is the system of embodiment 31 or 32 wherein one or more of the optical systems are replaceable.
Embodiment 61 is the system of embodiment 31 or 32 wherein one or more components of the system are included in a single housing.
Embodiment 62 is the system of embodiment 31 wherein the cartridge further includes (i) a top wall and at least one openable/closeable port or (ii) a removable cover.
Embodiment 63 is the system of embodiment 31 or 32 wherein the cartridge walls include one or more optically transparent regions associated with a printing zone to facilitate directing excitation light projections into the printing zone through the one or more optically transparent regions.
Embodiment 64 is a method of printing one or more three-dimensional objects, the method comprising:

providing a volume of a photopolymerizable composition in a cartridge configured to contain a volume of a photopolymerizable composition, the cartridge comprising side walls, preferably four, attached to a bottom wall to define a volume space for containing the volume, the cartridge being configured for including one or more printing zones, wherein a printing zone is sized to facilitate being irradiated by one or more, preferably at least two, excitation light projections to at least partially form a three-dimensional printed object within the volume of photopolymerizable composition in the printing zone, and

directing the at least two excitation light projections into each printing zone to selectively photopolymerize the photopolymerizable composition at one or more selected locations in the printing zone.

Embodiment 65 is a method of printing one or more three-dimensional objects, the method comprising:

providing a volume of a photopolymerizable composition in a cartridge configured to contain a volume of a photopolymerizable composition, the cartridge including opposed end walls and including at least one port in at least one end wall of the cartridge for facilitating the introduction and/or removal of unpolymerized photopolymerizable composition and/or removal of one or more three-dimensional objects from the cartridge, the cartridge being configured for including one or more printing zones, wherein a printing zone is sized to facilitate being irradiated by one or more, preferably at least two, excitation light projections to at least partially form a three-dimensional printed object within the volume of photopolymerizable composition in the printing zone, and

directing the one or more, preferably at least two, excitation light projections into each printing zone to selectively photopolymerize the photopolymerizable composition at one or more selected locations in the printing zone to at least partially form a three-dimensional printed object within the volume of photopolymerizable composition in the printing zone.

Embodiment 66 is the method of embodiment 64 wherein the cartridge includes one or more ports in at least one wall, wherein at least one port is openable and closable.
Embodiment 67 is the method of embodiment 65 wherein a port is openable and closeable.
Embodiment 68 is the method of embodiment 65 wherein the cartridge includes a port at each end and wherein each port is openable and closeable.
Embodiment 69 is the method of embodiment 64 or 65 wherein the photopolymerizable composition displays non-Newtonian rheological behavior and the one or more, preferably at least two, excitation light projections are selectively directed into the printing zone to selectively photopolymerize the photopolymerizable composition at one or more selected locations in the printing zone to form a printed object without support structures.
Embodiment 70 is the method of embodiment 69 wherein the printed object remains at a fixed position or is minimally displaced in the unpolymerized photopolymerizable composition during formation.
Embodiment 71 is the method of embodiment 70 wherein minimally displaced comprises displacing the printed object by an amount that is acceptable for precisely reproducing the geometry of the object to be printed during time intervals required to form the object.
Embodiment 72 is the method of embodiment 64 or 65 wherein the one or more, preferably at least two, excitation light projections are selectively directed into the printing zone to selectively photopolymerize the photopolymerizable composition at one or more selected locations in the printing zone to form a printed object without support structures.
Embodiment 73 is the method of embodiment 64 or 65 wherein the cartridge has a uniform cross-section over its length dimension.
Embodiment 74 is the method of embodiment 64 or 65 wherein the cartridge has a rectangular or square cross-section.
Embodiment 75 is the method of embodiment 64 or 65 wherein the cartridge has a non-uniform cross-section over its length dimension.
Embodiment 76 is the method of embodiment 64 or 65 wherein the cartridge is optically transparent.
Embodiment 77 is the method of embodiment 64 or 65 wherein the cartridge is optically flat.
Embodiment 78 is the method of embodiment 64 or 65 wherein the cartridge includes one or more optically transparent regions positioned for directing the excitation light projection(s) and passage of the excitation light projections into a printing zone in the cartridge.
Embodiment 79 is the method of embodiment 64 wherein the cartridge further includes further includes (i) a top wall and at least one openable/closable port or (ii) a removable cover.
Embodiment 80 is the method of embodiment 64 or 65 wherein the method is carried out in an inert atmosphere.
Embodiment 81 is the method of embodiment 64 or 65 wherein the method is carried out in a non-inert atmosphere.
Embodiment 82 is the method of embodiment 64 or 65 further including separating the at least partially formed three-dimensional objects from unpolymerized photopolymerizable composition included in cartridge.
Embodiment 83 is the method of embodiment 64 or 65 further comprising recycling unpolymerized photopolymerizable composition after separation of the at least partially formed three-dimensional objects from unpolymerized photopolymerizable composition.
Embodiment 84 is the method of embodiment 64 or 65 wherein the photopolymerizable composition displays non-Newtonian rheological behavior such that the object formed in the photopolymerizable composition within the printing zone remains at a fixed position or is minimally displaced in the unpolymerized photopolymerizable composition during formation, directing the excitation light through an optically transparent region of the cartridge into the printing zone to selectively photopolymerize the photopolymerizable composition in the printing zone without support structures to form a printed object, wherein the printed object remains at a fixed position or is minimally displaced in the unpolymerized photopolymerizable composition during formation.
Embodiment 85 is the method of embodiment 64 or 65 wherein the photopolymerizable composition comprises a photohardenable component and a photoswitchable photoinitiator, wherein the photoswitchable photoinitiator is activatable by exposure to light having a first wavelength and light having a second wavelength to induce a crosslinking or polymerization reaction in the photohardenable composition, wherein the first and second wavelengths are different.
Embodiment 86 is the method of embodiment 85 wherein the photopolymerizable composition displays non-Newtonian rheological behavior.
Embodiment 87 is the method of embodiment 85wherein the photopolymerizable composition further includes a coinitiator.
Embodiment 88 is the method of embodiment 85wherein the photopolymerizable composition further includes a sensitizer.
Embodiment 89 is the method of embodiment 85wherein the photopolymerizable composition further includes a synergist.
Embodiment 90 is the method of embodiment 85 optionally further including at least one of a coinitiator, a synergist, and a sensitizer.
Embodiment 91 is the method of embodiment 64 or 65further comprising post-treating the at least partially formed three-dimensional objects after separation from unpolymerized photopolymerizable composition.
Embodiment 92 is the method of embodiment 64 or 65 further comprising post-curing the at least partially formed three-dimensional objects after separation from unpolymerized photopolymerizable composition.
Embodiment 93 is the method of embodiment 64 or 65 further comprising inspecting the at least partially formed three-dimensional objects.
Embodiment 94 is the method of embodiment 64 or 65 wherein at least one of the optical systems comprises a digital micromirror display projection system.
Embodiment 95 is the method of embodiment 64 or 65 wherein at least one of the optical systems comprises a light sheet generating system.
Embodiment 96 is the method of embodiment 64 or 65 further including an optical system comprising a light sheet generating system.

Other information that may be useful in connection with the present invention includes International Patent Application No. PCT/US2021/035791 of Quadratic 3D, Inc. filed Jun. 3, 2021 for “Volumetric Three-Dimensional Printing Methods Including A Light Sheet And Systems” (which published as WO 2021/247930 A1 on Dec. 9, 2021), and U.S. Patent Application No. 63/223,112 of Quadratic 3D, Inc. filed Jul. 19, 2021, and International Application No. PCT/US2021/024878 of Quadratic 3D, Inc. filed Mar. 30, 2021 (which published as WO, 2021/202524 Al on Oct. 7, 2021), each of the foregoing being hereby incorporated herein by reference in its entirety.

The systems and methods of the present invention may be useful with other 3D printing techniques that include initiation of a photochemical reaction in a photoreactive system via the absorption of light energy supplied by one or more excitation light projections to form an object. Examples include tomographic printing, two-photon printing, upconversion printing, and dual-wavelength printing.

Before printing, a digital file of the object to be printed is obtained. If the digital file is not of a format that can be used to print the object, the digital file is then converted to a format that can be used to print the object. An example of a typical format that can be used for printing is an STL file. Typically, the STL file is then sliced into two-dimensional layers with use of three-dimensional slicer software and converted into G-Code or a set of machine commands, which facilitates building the object. See B. Redwood, et al., “The 3D Printing Handbook-Technologies, designs applications”, 3D HUBS B.V. 2018.

When used as a characteristics of a portion of a cartridge or build chamber, “optically transparent” refers to having high optical transmission to the wavelength of light being used, and “optically flat” refers to being non-distorting (e.g., optical wavefronts entering the portion of the cartridge or build chamber remain largely unaffected).

As used herein, the singular forms “a”, “an” and “the” include plural unless the context clearly dictates otherwise. Thus, for example, reference to an emissive material includes reference to one or more of such materials.

Applicant specifically incorporates the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

1-33. (canceled)

34. A method of printing one or more three-dimensional objects, the method comprising:
providing a volume of a photopolymerizable composition in a cartridge configured to contain a volume of a photopolymerizable composition, the cartridge comprising side walls attached to a bottom wall to define a volume space for containing the volume, the cartridge being configured for including multiple printing zones, wherein a printing zone is sized to facilitate being irradiated by at least two excitation light projections to at least partially form a three-dimensional printed object within the volume of photopolymerizable composition in the printing zone and to prevent objects printed in adjacent printing zones from touching each other during printing, wherein the photopolymerizable composition comprises a photohardenable component and a photoswitchable photoinitiator, and
directing the at least two excitation light projections into each printing zone to selectively photopolymerize the photopolymerizable composition at one or more selected locations in the printing zone to at least partially form a three-dimensional object in the printing zone.

35-38. (canceled)

39. The method of claim 34 wherein the photopolymerizable composition displays non-Newtonian rheological behavior and the at least two excitation light projections are selectively directed into the printing zone to selectively photopolymerize the photopolymerizable composition at one or more selected locations in the printing zone to form a printed object without support structures.

40. The method of claim 39 wherein the printed object remains at a fixed position or is minimally displaced in the unpolymerized photopolymerizable composition during formation.

41. The method of claim 40 wherein minimally displaced comprises displacing the printed object by an amount that is acceptable for precisely reproducing the geometry of the object to be printed during time intervals required to form the object.

42. The method of claim 34 wherein the at least two excitation light projections are selectively directed into the printing zone to selectively induce a polymerization and cross-linking reaction in the photopolymerizable composition at one or more selected locations in the printing zone to form a printed object without support structures.

43-47. (canceled)

48. The method of claim 34 wherein the cartridge includes one or more optically transparent regions positioned for directing the excitation light projection(s) and passage of the excitation light projections into a printing zone in the cartridge.

49. The method of claim 34 wherein the cartridge further includes a removable cover.

50. (canceled)

51. The method of claim 34 wherein the method is carried out in a non-inert atmosphere.

52. The method of claim 34 further including separating the at least partially formed three-dimensional objects from unpolymerized photopolymerizable composition included in cartridge.

53. (canceled)

54. The method of claim 34 wherein the photopolymerizable composition displays non-Newtonian rheological behavior such that the object formed in the photopolymerizable composition within the printing zone remains at a fixed position or is minimally displaced in the unpolymerized photopolymerizable composition during formation, directing the excitation light through an optically transparent region of the cartridge into the printing zone to selectively photopolymerize the photopolymerizable composition in the printing zone without support structures to form a printed object, wherein the printed object remains at a fixed position or is minimally displaced in the unpolymerized photopolymerizable composition during formation.

55. The method of claim 34 wherein the photopolymerizable composition comprises a photohardenable component and a photoswitchable photoinitiator, wherein the photoswitchable photoinitiator is activatable by exposure to light having a first wavelength and light having a second wavelength to induce a crosslinking or polymerization reaction in the photohardenable composition, wherein the first and second wavelengths are different.

56. The method of claim 55 wherein the photopolymerizable composition displays non-Newtonian rheological behavior.

57. The method of claim 55 wherein the photopolymerizable composition further includes a coinitiator.

58-60. (canceled)

61. The method of claim 34 further comprising post-treating the at least partially formed three-dimensional objects after separation from unpolymerized photopolymerizable composition.

62. The method of claim 34 further comprising post-curing the at least partially formed three-dimensional objects after separation from unpolymerized photopolymerizable composition.

63. The method of any one of claims 34 further comprising inspecting the at least partially formed three-dimensional objects.

64. The method of claim 34 wherein at least one of the optical systems comprises a digital micromirror display projection system.

65. The method of claim 34 wherein at least one of the optical systems comprises a light sheet generating system.

66. The method of claim 64 further including an optical system comprising a light sheet generating system.

67. (canceled)
